(19) United States
(12) Patent Application Publication
(10) Pub. No.: US 2006/0194334 A1
(43) Pub. Date: Aug. 31, 2006

(54) Probes for optical micromanipulation

(75) Inventor: Dahong Zhang, Corvallis, OR (US)

Correspondence Address: KLARQUIST SPARKMAN, LLP, 121 SW SALMON STREET, SUITE 1600, PORTLAND, OR, 97204, US

(73) Assignees: The State of Oregon Acting by and through the State Board of Higher Education; on Behalf of Oregon State University

(21) Appl. No.: 11/069,584

(22) Filed: Feb. 28, 2005

(51) Int. Cl. G01N 21/64

(52) U.S. Cl. 436/172

(57) ABSTRACT

A fluorescence microscopy system includes a probe configured to deliver an optical manipulation beam to one or more selected specimen regions. In a selected example, the probe includes a hollow light guide formed by a quartz capillary tube, and surrounded by a fluorescent sheath. Probes also include light guides defined by cavities in fluorescent glass. Such fluorescent probes can be imaging using fluorescence produced by an excitation light flux selected to produce specimen fluorescence.

### STATEMENT REGARDING FEDERALLY SPONSORED RESEARCH

The U.S. Government has a paid-up license in this invention and the right in limited circumstances to require the patent owner to license others on reasonable terms as provided by the terms of Contract No. S0636A-NSF-MCB-0090725 awarded by the National Science Foundation.

### TECHNICAL FIELD

The disclosure pertains to methods and apparatus for optical manipulation of specimens.

### BACKGROUND

Micromanipulation of cellular constituents with microneedles and ultraviolet or laser microbeams is a powerful technique for exploring cellular dynamics. Unfortunately, conventional micromanipulation methods exhibit several significant limitations for practical uses. For example, conventional microneedles are difficult to observe in fluorescence microscopy based specimen manipulations which makes simultaneous micromanipulation and observation of fluorescent specimens extremely difficult or impossible. Ultraviolet microbeams applied to specimens typically have cross-sectional areas that are larger than 2 μm² and observation of such beams is difficult. As a result, micromanipulations using ultraviolet beams generally result in ultraviolet irradiation of specimen regions that are not targeted for ultraviolet exposure and thus produce unnecessary free radicals that are harmful to the specimen. Conventional micromanipulation systems do not permit simultaneous detection of an ultraviolet beam and observation of the interaction of the specimen and the ultraviolet beam. Instead, prior to ultraviolet exposure of the specimen, one or more optical components are moved into position for optical alignment of the ultraviolet beam.

Additional difficulties are presented in the alignment of a microscope system to use ultraviolet light to produce specimen fluorescence. Because the necessary ultraviolet radiation can be difficult or dangerous to observe directly, alignment of ultraviolet sources typically requires a complex, multi-step procedure that is highly dependent on microscope user training and experience. Alignment can be critical, as specimen fluorescence is typically proportional to the incident ultraviolet optical power, and misalignment can result in fluoresence signals that are difficult or impossible to view or detect. Thus, considerable time and effort is often required merely to obtain satisfactory delivery of an ultraviolet light to a specimen.

In view of these and other limitations, improved methods and apparatus are needed.

### SUMMARY

According to representative examples, apparatus comprise an input, an output, and a guide section configured to couple the input and the output, wherein at least one of the input, the output, and the guide section are configured to fluoresce in response to a stimulation beam. In some examples, the guide section includes a capillary tube that defines a cavity, and the cavity is configured to couple the input and the output. In additional examples, a fluorescent sheath at least partially surrounds the guide section or the output, or an outer surface of the guide section or the output is at least partially coated with a fluorescent material. In other examples, the fluorescent material is uranium glass, and the guide section includes a uranium glass capillary. In additional examples, the guide section includes an interior cavity, and a surface of the cavity is configured to fluoresce. In still further examples, the light guide is defined by a needle having a fluorescent coating.

Representative systems for optical processing of a specimen comprise an imaging light source configured to provide an imaging light beam that propagates along an imaging beam axis to the specimen. An optical processing beam source is configured to provide an optical processing beam to the specimen. A beam combiner is situated along the imaging beam axis to direct the optical processing beam along the imaging beam axis, wherein a portion of the imaging beam incident to the beam combiner is substantially prevented from reaching the specimen. In representative examples, the beam combiner is a beamsplitter that includes a coating that substantially reflects the optical processing beam, and the coating is a dichroic coating. In other examples, the beam combiner is a mirror that includes a metallic reflective surface. According to additional examples, the imaging beam is selected to produce fluorescence in the specimen. In further examples, the beam combiner is situated to obstruct less than about 10% of the imaging light beam. In other examples, a probe is coupled to the specimen, and in a particular example, the probe defines a cavity that is coupled to the specimen. In further representative examples, at least a portion of the probe is configured to fluoresce in response to the imaging light beam. In additional examples, the probe includes a needle having an effective aperture dimension of at least as small as about 0.1 μm.

Methods for specimen observation and manipulation comprise providing an excitation flux configured to produce fluorescence in the specimen, and delivering at least a portion of the excitation flux to the specimen. A probe is coupled to the specimen, and fluorescence is produced in at least a portion of the probe in response to the excitation flux. In further examples, a processing light flux is coupled to the specimen with the probe. In some examples, the processing light flux is selected to photobleach or ablate at least a portion of the specimen. In representative examples, the probe includes a cavity coupled to the specimen, and a processing material is coupled to the specimen via the cavity or a specimen constituent is extracted via the cavity. In other representative examples, at least a portion of the specimen is fluorescently labeled. In further representative examples, the specimen and the probe are imaged based on specimen fluorescence and probe fluorescence, respectively, produced in response to the excitation flux. The probe is positioned with respect to the specimen based on the imaging, and a processing light flux is coupled to the specimen via the probe.

Optical power sensors for beam alignment comprise an optical detector and a substrate configured to receive the optical detector and to be retained on a microscope substrate stage. In additional examples, an electrical connection is secured to the substrate and coupled to the optical detector. In further examples, the substrate has dimensions that are substantially equal to microscope slide dimensions.

Optical sensor assemblies configured for attachment to a microscope objective turret comprise a sleeve that includes a threaded portion configured for attachment to the turret. An optical detector is retained by the sleeve, and an electrical output is in communication with the optical detector. In representative examples, a lens is retained by the sleeve and configured to direct received optical radiation along an axis of the sleeve, wherein the optical detector is situated along the sleeve axis.

These and other features and advantages will become more readily apparent from the following detailed description which proceeds with reference to the accompanying drawings.

### BRIEF DESCRIPTION OF THE DRAWINGS

FIG. 1 is a schematic diagram of a microscope system configured for fluorescence microscopy of and delivery of an optical processing beam to a specimen.

FIG. 2A is a schematic block diagram of an apparatus configured to deliver an optical processing beam to a specimen.

FIGS. 2B-2E are schematic diagram of representative probes configured to couple optical processing beams to a specimen, or the deliver or extract materials from a specimen.

FIG. 3 is a schematic diagram of a microneedle assembly that includes an LED and a microneedle.

FIG. 4 is a schematic block diagram of an apparatus that provides radiation in a selected spectral range to a microneedle for delivery to a specimen.

FIGS. 5A-5C illustrate representative power meter configurations for ultraviolet/visible optical alignment.

FIG. 5D is a block diagram of a representative system for microscope alignment using a power meter such as illustrated in FIGS. 5A-5C.

FIG. 6A illustrates a power meter configured to be situated on a microscope objective lens barrel.

FIG. 6B illustrates a power meter configured in a microscope object lens barrel.

### DETAILED DESCRIPTION

In the following description, methods, systems, and apparatus are described that can provide manipulations and processing of specimens having dimensions at least as small as 1 μm. Typical specimen manipulation and processing includes mechanical manipulations such as cutting, severing, dislocating, translating, or orienting, as well as optical processing such as photobleaching, photoablation, or photoactivation, and other chemical or physical manipulation or processing, such as injection of beads, particles, or reagents onto or into a specimen, or extraction of material from the specimen. The examples described below are representative examples only.

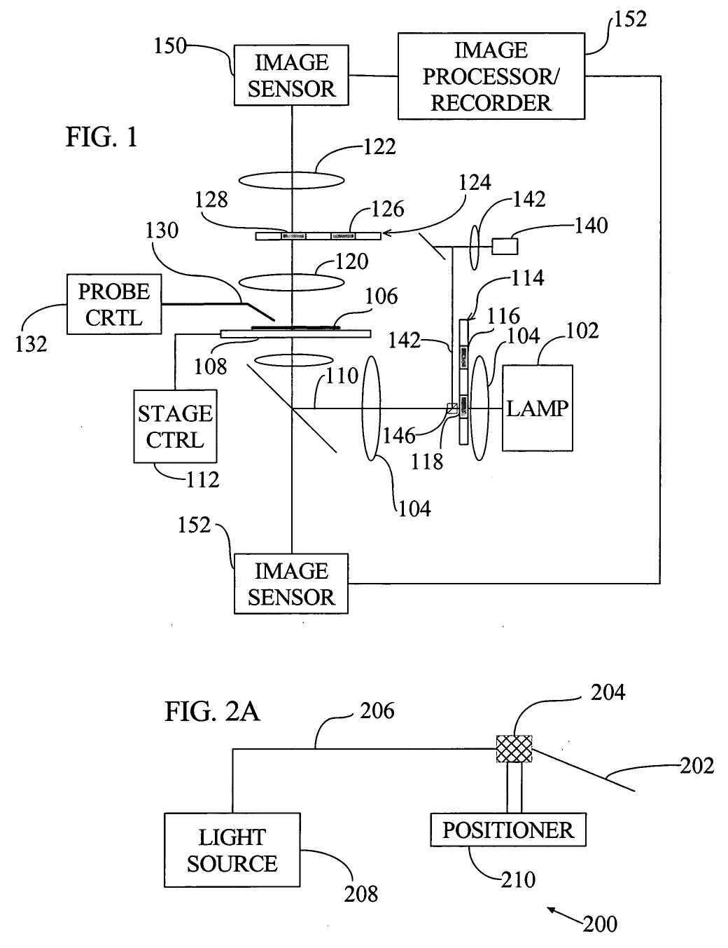

A representative microscope system configured for direct and/or fluorescence imaging and optical manipulation of specimens is illustrated in FIG. 1. A light source 102 such as, for example, a tungsten halogen lamp, xenon arc lamp, mercury-xenon arc lamp, metal halide arc lamp, laser, or light emitting diode, and one or more condenser lenses 104 or other optical elements such as mirrors, prisms, beamsplitters are configured to produce an excitation beam that is delivered to a specimen 106 that is retained on or supported by a specimen stage 108. The excitation beam is generally delivered along an illumination axis 110 that can be bent, folded, or otherwise arranged for convenient specimen illumination. Movement of the specimen stage along and perpendicular to the axis 110 for focusing and selection of portions the specimen 106 for investigation can be controlled with a stage controller 112, or manual stage control mechanisms can be provided.

The illumination beam can be shaped with one or more illumination apertures (not shown in FIG. 1), and typically the illumination beam can be delivered to the specimen to provide so-called Kohler illumination or Abbe illumination as needed. As shown in FIG. 1, a sliding filter assembly 114 includes filters 116, 118 that are configured to permit selection of excitation beam spectral windows for specimen illumination. Additional or fewer filters can be provided. Filters can also be conveniently provided using a filter wheel, or individual filters can be used. For fluorescence-based imaging, the illumination beam spectrum is selected to include radiation at wavelengths at which a selected specimen fluoresces, and typical excitation radiation wavelengths are between about 350 nm and 550 nm, but other wavelength ranges can be used for excitation. In some applications, specimens are treated with one or more fluorophores to provide fluorescence. A mercury-xenon arc lamp can provide substantial radiation at some of these wavelengths, and is a convenient light source. Other lights sources, including coherent sources, can be used instead.

Portions of the illumination beam, or radiation induced by the illumination beam, such as, for example, specimen fluorescence, are received by an objective lens 120 and delivered to an eyepiece lens 122. Lenses 104, 120, 122 are shown in FIG. 1 as single refractive elements, but in other examples, one or more reflective or refractive elements can be used. While an eyepiece lens can be provided for direct specimen observation by a microscope user, specimen images can be projected or viewed with a video camera or other image sensor such as the image sensor 150. In other examples, microscope systems can be provided as so-called “inverted” microscopes, or arranged to deliver the illumination beam to a specimen along the same optical path as the radiation used for specimen imaging. As shown in FIG. 1, the imaging optical system can be arranged so that the image sensor 150 is situated on the side of the specimen 106 from which the illumination/excitation beam is provided. The image sensor 150 is in communication with an image processor/recorder 152 configured to store and process images.

As shown in FIG. 1, a viewing filter assembly 124 includes optical filters 126, 128 that can be selected to attenuate or block the excitation beam while transmitting fluorescence produced by the excitation beam to the eyepiece or other imaging optics. Alternatively, optical filters can be provided to enhance contrast in other ways, or to polarize or otherwise process light received from the specimen. The filters 126, 128, 116, 118 can be, for example, absorptive filters such as glass or gelatin filters, dichroic filters, or polarizing filters.

Specimen manipulation can be provided with a probe 130 that is positioned with a probe controller 132, or that can be manually controlled with a joystick or other mechanism. The probe 130 can be a needle configured to inject material into the specimen or withdraw material from the specimen. Alternatively, the probe 130 can include a probe tip configured to cut or otherwise mechanically disrupt the specimen in one or more regions. In other examples, the probe is configure to deliver radiation such as, for example, infrared, ultraviolet, or visible radiation to heat, produce photochemical changes, move or otherwise manipulate the specimen. In a particular example, one or more probe such as the probe 132 are provided for specimen manipulation using respective optical wavelengths, such as wavelengths associated with green and red.

A light source 140, such as a laser, LED, arc lamp, or other source, and beam shaping optics 142 such as one or more lenses, are situated to deliver an optical processing beam along an axis 142 to a beamsplitter 146. In FIG. 1, the beamsplitter is shown as a cube beamsplitter, but a plate beamsplitter, mirror, or other beamsplitter or beam combiner can be used instead. The axis 142 and other optical propagation axes can be folded or bent using prisms, mirrors, or other optical elements. The beamsplitter 146 is situated in the path of the excitation beam, but is generally selected to block or occupy only a portion of the cross-sectional area of the excitation beam, and the excitation beam is substantially transmitted to the specimen. In a representative example, a 3 mm square beam splitter cube is used, and the excitation beam cross section is about 25 mm in diameter. The beamsplitter 146 is configured to substantially reflect the processing beam produced by the source 140, and direct the processing beam along the axis 110 substantially parallel to the axis 110. Such an arrangement is convenient, but in other examples, the excitation beam on the processing beams can propagate along different axes and/or are not parallel. The system of FIG. 1 can be configured so that a specimen portion is selected to receive the optical processing beam by adjustment of the processing beam optical path, or other optical system adjustments. Placement of the processing beam can be arranged by viewing the tip that delivers the processing beam, or based on fluorescence induced in the tip or other light guide by a processing beam or other excitation beam, or based on probe beam radiation. With the arrangement of FIG. 1, a specimen can be ablated or otherwise processed with an optical beam while under observation.

The light source 140 is selected to produce an optical processing beam based on an intended optical processing. For example, the optical processing beam can be configured for specimen ablation, photobleaching, photoactivation, or for other specimen interactions. For example, the optical processing beam can be configured to locally bleach, kill one or more selected cells, selectively disrupt cell walls, or locally stimulate a chemical reaction. The optical processing beam can have various wavelengths, but, for convenience, laser diode wavelengths can be selected and the light source 140 can include a laser diode. In addition, the light source 140 can produce a pulsed beam or a continuous beam, and can include one or more wavelengths or wavelength bands that are produced sequentially, simultaneously, periodically, or otherwise arranged. For example, two laser diodes that emit at different wavelengths can be used, and the beams configured to propagate along or parallel to the axes 110, 142.

In the example of FIG. 1, an optical processing beam is delivered to a specimen in conjunction with an excitation beam configured to produce specimen fluorescence, or other illumination beam. As shown in FIG. 1, an optical processing beam is configured to propagate along an axis that is parallel to or overlaps an excitation beam axis (for fluorescence imaging) and/or an illumination beam axis (for conventional light imaging). By controlling processing beam diameter and the size of the beamsplitter 146, the beam splitter 146 interferes with or obstructs only a portion of the excitation or illumination beam, and the specimen can be imaged with the beamsplitter 142 in place, i.e., during processing. Typical excitation wavelength ranges for excitation of specimen fluorescence are near wavelengths of about 365 nm, 390 nm to 440 nm, 435 nm to 490 nm, and 500 nm to 546 nm. As used herein, fluorescence includes photoluminescence and refers to radiation induced by an excitation beam at wavelengths that are typically longer than and somewhat independent of wavelengths associated with the excitation beam.

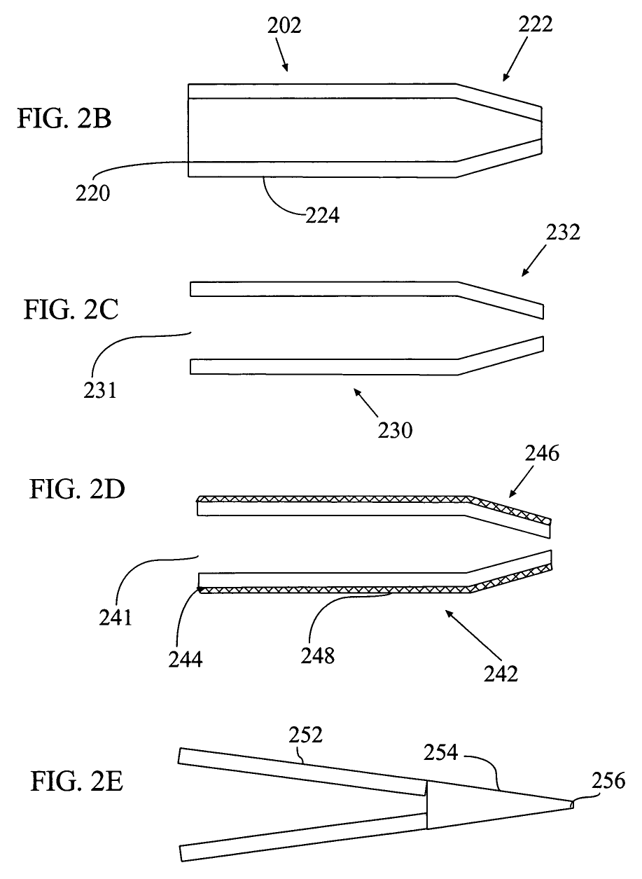

Example probes suitable for delivery of optical processing beams or for use in other type of specimen processing, manipulation, or microsurgery are illustrated in FIGS. 2A-2B. In the example of FIG. 2A, an optical beam system 200 includes a probe 202 that is in communication with a probe coupler 204 configured to couple the probe 202 to a light guide 206 that receives optical radiation from a light source 208. The light guide 206 is conveniently an optical fiber, hollow waveguide, or other optical waveguide to provide a flexible interconnection, but other interconnections can be used. An optical beam can be guided based on, for example, refractive index differences between a core region and a cladding region as in conventional communication optical fibers, or by total internal reflection at a dielectric interface, or reflection from a metallic surface. The probe 202 is typically fixed to a positioning assembly 210 that can provide translations or rotations along or about one or more axes. The positioning assembly 210 can be controlled manually using, for example, micrometer screws or piezoelectric devices, or positioning can be controlled using a personal computer, a personal digital assistant, or other electronic control device.

With reference to FIG. 2B, the probe 202 includes a light guide section 220 configured to receive and deliver probe radiation. The light guide section can be formed of quartz, fused silica, glass, sapphire, plastic, or other material that is sufficiently transmissive at processing beam wavelengths. For ultraviolet wavelengths, fused silica is particularly convenient because is generally transmissive and can be formed into fiber light guides of diameters at least as small as that of a single mode optical fiber for such wavelengths. Alternatively, hollow light guides capillaries of fused silica or other materials can be used. Hollow (cavity) light guides can be conveniently formed of fused silica to have internal diameters or other aperture dimensions of less that 5 μm. Light guides having circular cross sections can be conveniently fabricated, but other cross sections such as, for example, rectangular or elliptical can also be used. In other examples, glass or metal tubes can be used to define light guides in a similar manner. Although light guides defined by cavities in dielectric media permit propagation of radiation over a wide spectral range, even slight penetration of fields into dielectric media can produce unwanted optical attenuation if for media that are absorptive at processing beam wavelengths.

The light guide section 220 is coupled to or formed with a tip region 222 that is shaped for optical beam delivery. Such a tip region can be configured as a tapered light guide region, a light diffusion region, a cone, a lens region, or otherwise arranged. A probe end having a diameter of about 0.5 μm and that is substantially planar and perpendicular to a propagation direction in the light guide 220 can provide a suitable beam diameter and divergence for radiation exiting the light guide 220. The probe 202 includes a cladding 224 that is selected to control, reduce, or eliminate radiation delivery through a wall of the probe 202. The cladding can be an opaque coating such as a black coating, or a metallic coating. Alternatively, a transparent cladding region can be provided having a sufficiently different index of refraction from the light guide 221 so that radiation propagating the light guide 220 tends to be confined in the light guide 220, and is substantially prevented from escaping at light guide sidewalls. In other examples, the cladding 224 can be formed of a fluorescent material or treated so as to fluoresce in use. FIG. 2B shows a tapered region at an end of the probe 202, but a gradual taper over a substantial length of a light guide region can be provided instead.

An alternative probe is illustrated in FIG. 2C. A light guide 230 is defined by a cavity 231 in a uranium glass tube. In other examples, light guides can be formed in glass tubes or metallic needles or metallic tubes, or using cavities in other materials such as, for example, metallic uranium. A tip region 232 is configured to deliver radiation from the light guide 230 and provide a distribution of emitted radiation based on a selected application. Uranium glass is particularly convenient as it fluoresces upon exposure to ultraviolet excitation beams, and thus, while transparent, is easily viewed during procedures carried out using fluorescence microscopy, or other applications that include an excitation beam configured to produce fluorescence. Probes can be formed of other materials such as fused silica, glass, or plastic to which one or more fluorophores such as heavy metals, semiconductor quantum dots, or other fluorophores can be attached or incorporated. One or more surfaces of glass, plastic, metallic or other probes can be coated or partially coated with a fluorescent material. For example, a hollow fused silica waveguide can be at least partially coated with a fluorescent glass by sputter coating or other techniques. In other examples, a glass, plastic, metallic, or other light guide or light guide assembly is provided with a fluorescent sheath. For example, a fused silica fiber, tube, or capillary can be situated substantially within a uranium glass tube that covers an outer surface. Metallic light guides can be similarly configured with an exterior fluorescent jacket. In other examples, probes are configured so that radiation received for delivery to a specimen stimulates fluorescence of at least a portion of the probe. While in some examples, such probes are configured to deliver an optical beam to a specimen, in other examples, probes are configured to deliver a reagent or other material such as beads to a specimen, or to extract materials from a specimen. Alternatively, probes can be configured to mechanically manipulate a specimen by, for example, cutting, dragging, pushing, or rotating the specimen. Such probes can be configured for optical beam delivery, material extraction and delivery, and specimen movement or cutting using the optical beam.

Another representative probe is illustrated in FIG. 2D. A cavity 241 defined in a quartz capillary tube 242 is configured to couple radiation (or reagents) from a first end 244 to a probe tip 246. A fluorescent sheath or other fluorescent coating 248 is provided to enhance probe visibility. An additional representative probe is illustrated in FIG. 2E. A tapered capillary 252 such as, for example, a fused silica capillary, is coupled to a tapered uranium glass section 254 that terminates in a surface 256 that serves as an aperture from which radiation can be delivered.

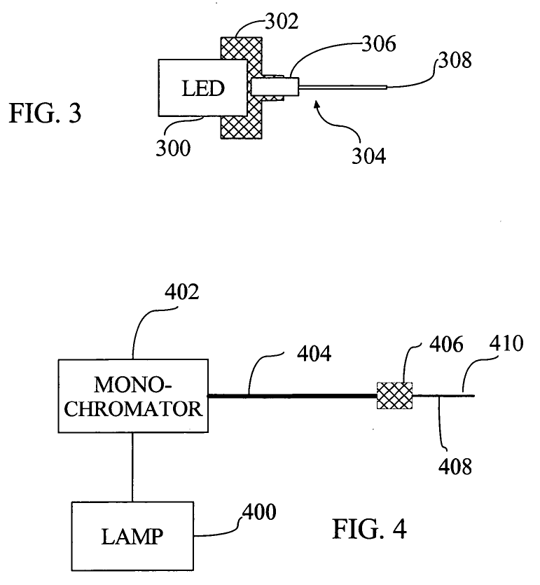

With reference to FIG. 3, a microneedle assembly includes an LED 300 and an LED/microneedle adaptor 302. A laser diode or a fiber coupled laser can also be used. A microneedle 304 includes a shank region 306 and a light emitting tip 308. The shank region can be configured for connection to the LED 300 with the adaptor 302. The LED 300 can be selected based on specimen properties or other factors, and in some applications one or more such microneedle assemblies can be used to maneuver and/or dissect fluorescently labeled cellular constituents such as microtubules, actin filaments, chromosomes, or other materials. The light emitting tip can be formed by, for example, pulling from uranium glass that emits blue light in response to ultraviolet exposure. Microneedle tips can be as small as about 1 μm or less.

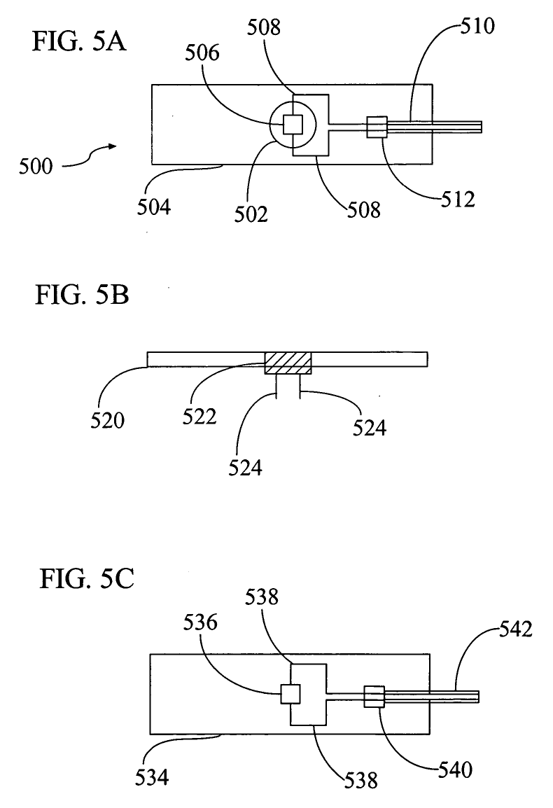

Referring to FIG. 4, a mercury arc lamp 400 or other light source is coupled to a monochromator 402 for selection of radiation of a particular wavelength or wavelength range for delivery to a light guide 404. A coupler 406 is configured to receive the light guide 404 and a quartz microneedle 408, and couple radiation from the monochromator 402 to a microneedle tip 410. A lamp controller, shutter, or attenuator can be provided to control power or pulse shape of radiation delivered to the specimen.

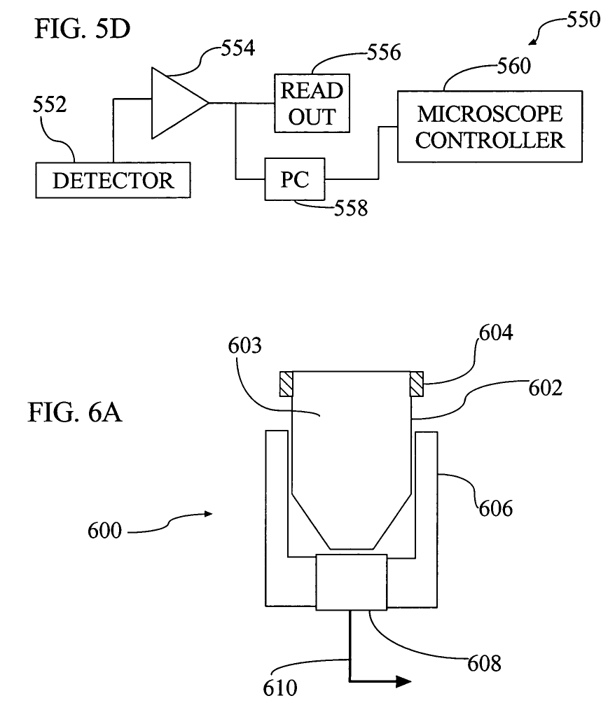

With reference to FIG. 5A, a power sensor 500 includes a radiation detector 502 such as, for example, a silicon photodiode or other infrared, visible, and/or ultraviolet light detector that is coupled to a substrate 504. A microscope slide is conveniently selected for the substrate 504, but other substrate can be used. Typically, the substrate 504 is selected to be readily mounted on a microscope stage. The detector 502 includes a detector chip 506 or other radiation sensitive region, and electrical connections 508 couple the detector 502 to an output cable 510. The output cable 510 can be a coaxial cable, a twisted pair, or two separated wires. The output cable 510 and the electrical connections 508 can be fixed to the substrate 504 at one or more support regions, such as a support region 512 with an epoxy or other adhesive, solder, or with a conventional electrical connector or other mechanism. A pattern can be provided so that a center or other portion of the detector chip 506 can be identified and used in an alignment process.

FIG. 5B shows a cross-sectional view of a representative power meter assembly. A support 520 (such as, for example, a microscope slide) includes an aperture configured to receive a detector 522. Detector leads 524 are provided to deliver the electrical signal to an amplifier, a voltmeter, or other instrumentation configured to receive the electrical signal.

FIG. 5C illustrates an additional representative example of a power meter sensor configured for use with a microscope system. The power meter sensor includes a sensor chip 536 situated on a support 534. The sensor chip 536 is coupled by conductors 538 to an output cable 542 through a connection 540. The conductors 538 can be conveniently defined in a conductive material that is deposited on the support 534. In other examples, the output cable 542 is omitted, and contact pins or a connector are configured for direct attachment of the power meter sensor to any associated detector electronics such as buffers, amplifiers, or other current and/or voltage detection electronics.

FIG. 5D illustrates microscope alignment using a power meter such as any of those illustrated in FIGS. 5A-5C. A microscope stage photodetector (or other microscope alignment detector) 552 is coupled to an amplifier 554 that delivers an associated electrical signal to a readout 556, such as, for example, an analogue or digital readout. The amplifier 554 is also coupled to a personal computer 558 or other processor unit such as a personal digital assistant, a latptop computer, a desktop computer, or a dedicated detector processor that is in communication with a microscope controller 558. Alternatively, the amplifier can be configured to communicate directly with the microscope controller. As shown in FIG. 5D, a user can manually adjusted microscope alignment based on the power level or other power indication on the readout 556, or, base on the power indication, the microscope controller can align the microscope.

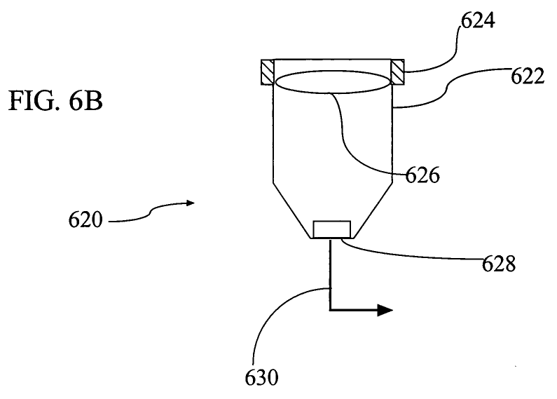

Referring to FIG. 6A, an optical sensor 600 includes a sleeve 606 or other support configured to retain a detector 608 on an outer surface 602 of a microscope objective 603. The sleeve 606 can be configured to be supported on the microscope objective 603 using friction, or clips, setscrews, or other attachment mechanism can be used. The microscope objective 603 typically is attached to a microscope stand using external screw threads 604.

With reference to FIG. 6B, an optical sensor 620 includes an optical detector 628 retained by a microscope objective housing having screw threads 624 or other mechanism for attachment to a microscope objective turret. The sensor 620 can include one or more lenses or other optical elements such as a lens 626. An electrical signal from the optical detector 628 is coupled to other detection circuitry via a cable 630 or other connection.

While representative embodiments are described above, these embodiments should not be construed as limiting in any way. Instead, the present disclosure is directed toward all novel and nonobvious features and aspects of the various disclosed embodiments, alone and in various combinations and subcombinations with one another. The methods are not limited to any specific aspect or feature or combinations thereof, nor do the disclosed methods require that any one or more specific advantages be present or problems be solved. The several representative embodiments are disclosed herein for purposes of illustration.

I claim:

1. An optical probe, comprising:
an input;
an output; and
a guide section configured to couple the input and the output, wherein at least one of the input, the output, and the guide section are configured to fluoresce in response to a stimulation beam.

2. The probe of claim 1, wherein the guide section includes a capillary tube that defines a cavity, and the cavity is configured to couple the input and the output.

3. The probe of claim 1, wherein the guide section further comprises a fluorescent sheath at least partially surrounding the guide section.

4. The probe of claim 1, wherein at least a portion of an outer surface of the guide section is at least partially coated with a fluorescent material.

5. The probe of claim 4, wherein the fluorescent material is uranium glass.

6. The probe of claim 1, wherein the guide section includes a uranium glass capillary.

7. The probe of claim 1, wherein the guide section includes a tapered section of uranium glass.

8. The probe of claim 1, wherein the light guide is defined by a needle having a fluorescent coating.

9. A system for optical processing of a specimen, comprising:
an imaging light source configured to provide an imaging light beam that propagates along an imaging beam axis to the specimen;
an optical manipulation beam source configured to provide an optical manipulation beam to the specimen; and
a beam combiner situated along the imaging beam axis to direct the optical manipulation beam along the imaging beam axis, wherein a portion of the imaging beam incident to the beam combiner is substantially prevented from reaching the specimen.

10. The system of claim 9, wherein the beam combiner is a beamsplitter that includes a coating that substantially reflects the optical processing beam.

11. The system of claim 9, wherein the coating is a dichroic coating.

12. The system of claim 9, wherein the beam combiner is a mirror.

13. The system of claim 12, wherein the mirror includes a metallic reflective surface.

14. The system of claim 9, wherein the imaging beam is selected to produce fluorescence in the specimen.

15. The system of claim 9, wherein the beam combiner interacts with less than about 10% of the imaging light beam.

16. The system of claim 9, further comprising a probe configured for coupling to the specimen.

17. The system of claim 16, wherein the probe defines a cavity coupled to the specimen.

18. The system of claim 17, wherein at least a portion of the probe is configured to fluoresce in response to the imaging light beam.

19. The system of claim 16, wherein the probe includes a needle having an aperture of less than about 0.2 μm.

20. A method, comprising:
providing an excitation flux configured to produce fluorescence in a specimen;
delivering at least a portion of the excitation flux to the specimen;
coupling a probe to the specimen; and
producing fluorescence at at least a portion of the probe in response to the excitation flux.

21. The method of claim 20, further comprising coupling a processing light flux to the specimen with the probe.

22. The method of claim 21, wherein the processing light flux is selected to produce photobleaching in at least a portion of the specimen.

23. The method of claim 21, wherein the processing light flux is selected to ablate at least a portion of the specimen.

24. The method of claim 20, wherein the probe includes a cavity coupled to the specimen.

25. The method of claim 24, further comprising coupling a processing material to the specimen via the cavity.

26. The method of claim 24, further comprising extracting a specimen constituent via the cavity.

27. The method of claim 20, further comprising fluorescently labeling at least a portion of the specimen.

28. The method off claim 20, further comprising:
imaging the specimen and the probe based on specimen fluorescence and probe fluorescence, respectively, produced in response to the excitation flux;
positioning the probe with respect to the specimen based on the imaging; and
coupling a processing light flux to the specimen via the probe.

29. An optical power sensor, comprising:
an optical detector; and
a substrate configured to receive the optical detector and to be retained on a microscope substrate stage.

30. The sensor of claim 29, further comprising an electrical connection secured to the substrate and coupled to the optical detector.

31. The sensor of claim 29, wherein the substrate has dimensions that are substantially equal to microscope slide dimensions.

32. An optical sensor assembly configured for attachment to a microscope stand, comprising:
a sleeve that includes a threaded portion configured for attachment to the microscope stand;
an optical detector retained by the sleeve; and
an electrical output in communication with the optical detector.

33. The sensor assembly of claim 32, further comprising a lens retained by the sleeve and configured to direct received optical radiation along an axis of the sleeve, wherein the optical detector is situated along the sleeve axis.
